(19) United States
(12) Patent Application Publication
(10) Pub. No.: US 2009/0032225 A1
(43) Pub. Date: Feb. 5, 2009

(54) Method and Plant for Cooling Fluid Agglomerates Using Their Liquid Component as a Heat Carrier

(75) Inventor: Maurizio Frati, Milano (IT)

Correspondence Address: AIR LIQUIDE;Intellectual Property, 2700 POST OAK BOULEVARD, SUITE 1800, HOUSTON, TX, 77056, US

(73) Assignee: L'Air Liquide Societe Anonme Pour L'Etude Et L'Exploitation Des Procedes Georges Claude, Paris (FR)

(21) Appl. No.: 12/281,020

(22) PCT Filed: Feb. 23, 2007
(86) PCT No.: PCT/IB2007/051457

§ 371 Date: Aug. 28, 2008

(30) Foreign Application Priority Data
Feb. 28, 2006 (IT) MI2006A000355

(51) Int. Cl. F28D 15/00; F17C 5/00

(52) U.S. Cl. 165/104.19; 62/54.1

(57) ABSTRACT

Method for cooling in a controlled manner a fluid agglomerate or polyphase fluid, with a continuous or discontinuous flow, consisting of liquid and solid components, such as pressed grapes, said fluid being introduced and present inside an associated receptacle, it is envisaged removing from this agglomerate at least a part thereof, extracting it from the abovementioned receptacle, cooling it and then introducing it again inside the receptacle so as to use it again as a heat carrier or means for removing heat from the remaining part of the said fluid agglomerate present in the abovementioned receptacle.

The present invention relates to a method for cooling polyphase fluids, such as liquids containing solid parts, according to the preamble of the main claim. The invention also relates to a plant for implementing this method.

In the present text, for the sake of descriptive simplicity without this affecting the general nature of the invention, a “polyphase fluid” is understood as referring in particular to the product which is obtained from the process of crushing grapes, which process is known as pressing, producing a fluid agglomerate which is commonly referred to as pressed grape product, consisting of a liquid component, commonly known as must, and other components which are similar to solids, for the purposes of the present invention, such as the skin of the berries, the grape pips and in many cases also the grape stalks. This term (“polyphase fluid”) is understood, however, as also defining any liquid element containing solid particles such as, for example, alimentary juices or the like.

As is known, many modern vinification techniques, in order to obtain a final product, i.e. wine, which fully exploits the organoleptic potential of the vine, require that the grapes or the pressed product which is obtained therefrom should be at temperatures lower than those which exist usually during picking, for which reason cooling thereof is necessary. Purely by way of example it should be considered that a process for optimizing the results achieved with some types of vines is the process involving cold maceration of the pressed product, said process being performed at temperatures ranging between 5 and 10° C., while it is not unusual for the temperatures at which the grape is picked to be in excess also of 30° C.

Cooling, in order to exploit fully the potential of the grape, must be conducted in such a way as to limit to a minimum the mechanical stresses acting on the pressed product so as to prevent, as far as possible, damage (such as laceration) of the skins, and the further breakage of the berries and the grape pips contained therein.

At the present time, various methods for cooling the pressed product are known; some of these use pipe-in-pipe exchangers which exchange mechanical cold energy produced by refrigerating plants, others which use cold energy, known as cryogenic cold energy, obtained from the heat exchange with evaporating cryogenic liquids, such as CO₂ or N₂ (or the like) in the liquid state, in direct contact with the pressed product in suitable apparatus as described, for example, in the patent IT1313938 in the name of the same applicant.

The currently known techniques which use cryogenic cold energy, in order to minimize the friction and the consequent damage to the pressed product, allow heat exchange to be performed in apparatus where there is direct contact between the pressed product and the evaporating liquid, said apparatus operating at a variable pressure, namely at the pressure which is strictly necessary to overcome the losses of head for transfer of the pressed product to the next processing stage. These measures allow both minimization of the mechanical stress acting on the pressed product due to friction between the latter and the exchange apparatus and transfer of the cooled pressed product to the next processing stage without the aid of further pumping machines, thus eliminating the resultant mechanical stress.

The operating method described above in connection with cooling performed using mechanical cold energy, however, has various drawbacks. In particular, the main problem lies in its procedure and is due to mechanical stressing resulting from the friction which originates between the skins and the grape pips and the parts of the exchanger when the pressed product passes inside the latter, which friction, as seen, is the cause of laceration and breakage of the berries with consequent deterioration in the potential of the pressed product.

In order to have a yardstick of comparison with regard to the mechanical stress associated with the methods described above, it should be considered that in a mechanical cold energy exchanger with the correct dimensions, in order to lower by about 20° C. the temperature of the pressed product, between the upstream and downstream ends of the exchanger, head losses in the region of 2.5 to 3 bar occur, while in a cryogenic cold energy exchanger, with the correct dimensions, the head losses, still for the same temperature difference, are about 0.3 to 0.5 bar.

Since the head losses and mechanical stresses and friction are closely related, the above values indicate the different performance results of the two methods for maintaining the organoleptic potential of the pressed product.

The object of the present invention is to provide a method and a plant for cooling a polyphase fluid of the type mentioned, and in particular that resulting from the grape crushing process, which are improved compared to similar methods and plants already known.

In particular, the present invention consists in a method and a plant which, using both mechanical and cryogenic cold energy, allows cooling of the pressed product to be performed without producing a significant mechanical stress thereon.

Another object is that of offering a method and a plant of the type mentioned which allows an end product (in the case in question, although not exclusively, wine) with optimum organoleptic properties to be obtained.

Another object is to provide a method and a device which incorporate the method according to the patent application MI2005A000923, filed in the name of the same applicant, which describes a method for removing at least partly the oxygen dissolved in a liquid contained in a fluid agglomerate such as, in particular, grapes picked mechanically or pressed grapes introduced inside a tank or a receptacle (1) where the liquid is separated from the fluid agglomerate in a bottom part (1B) of said receptacle (1). According to this method, it is envisaged introducing a fluid able to remove, from this liquid or the agglomerate, the oxygen present therein, and if necessary cool this liquid or agglomerate, said operation of introducing this removal fluid being performed directly within this liquid.

These and other objects which will become obvious to the person skilled in the art are achieved by a method and a device according to the accompanying claims.

According to the present invention, cooling of a polyphase fluid, for example the pressed grape product, is performed without movement of its degradable components (in the example, berries, skins and grape pips), but only of the liquid component (must in this case) or part thereof, this component not being damaged by the movement and being used, according to the invention, as a fluid conveyor of cold energy or as a heat carrier for cooling the entire fluid (the pressed product in the example in question).

The invention is implemented by separating, in a special apparatus, called a separator, partly or totally the liquid component of the pressed product, which is conveyed, using systems known per se, into an exchanger where it is cooled and transferred, if necessary using transfer or pumping systems known per se, into a mixing apparatus, called a mixer. In this apparatus, the cooled liquid component, or heat carrier, is mixed with the pressed product, from which it was separated previously and from which heat is drawn: the overall result will be a lowering of the entire temperature of the pressed product.

The apparatus where mixing of the pressed product and the cooled must is performed must be such as to guarantee the fluid contained therein a contact time suitable for allowing a sufficient uniformity of temperature to be reached in the entire stored mass.

Said contact time may be defined, as is known, by dividing the volume of the apparatus by the volumetric flowrate of the fluids passing through it where this is continuous, or as simple stay time in the case of discontinuous processing, necessary for a sufficiently uniform temperature. It depends on various factors, mainly the degree of mixing between the heat carrier and the remaining part of the fluid and the dimensions of the solid components, in addition, obviously, to the thermal conductivity of the components of the fluid.

In the case of pressed grapes, with usual mixing such as that obtained by blowing in relatively small quantities of gas into the mixer or by means of gentle mechanical stirring, the stay time considered sufficient may vary from 1 to 3 minutes, the higher value for grapes being characterized by larger size berries.

The invention may be applied both to continuous flows of pressed product to be cooled and to discontinuous cooling operations.

For greater understanding of the present invention, purely by way of a non-limiting example, the following figures are attached, in which:

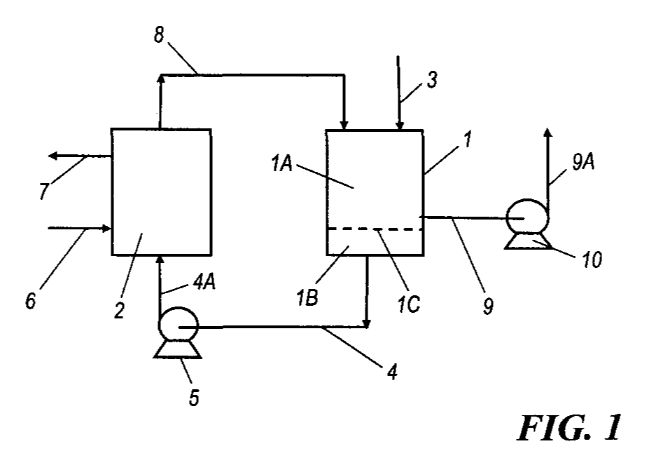

FIG. 1 shows a schematic view of a plant obtained according to the present invention; and

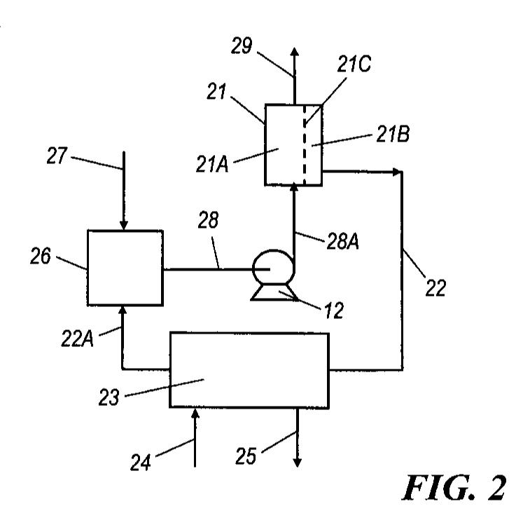

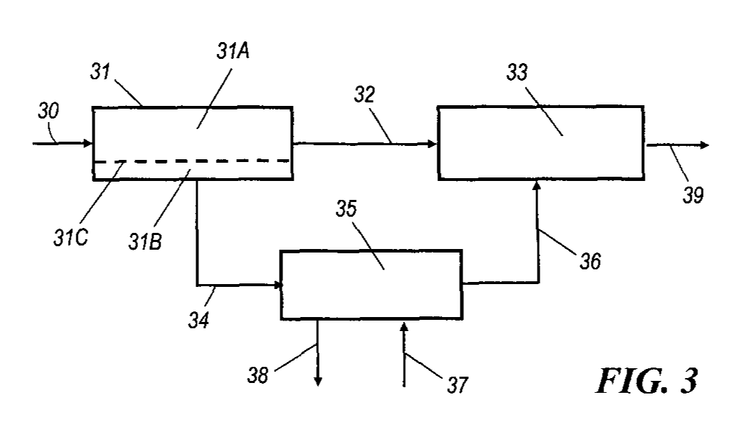

FIGS. 2 and 3 show two variants of the invention according to FIG. 1.

Let us refer now to FIG. 1; this figure shows an apparatus for collecting the pressed product 1 which is known per se and performs the functions of collecting and separating the must and ensuring a uniform temperature; this apparatus is composed of three parts or components, namely a first part 1A containing the pressed product, a second part 1B containing only the must, and a third part 1C defined by a component which allows separation of the must from the remaining portions of the polyphase fluid. Said component may be defined by a grid separating the pressed product from the must, as in the tank or receptacle for storing grapes described in the patent application MI2005A000923 mentioned above and filed in the name of the same applicant.

The pressed product is introduced into the receptacle 1, into the part 1A thereof, by means of any supply system or device 3 known per se, for example a hopper, using methods involving a continuous or discontinuous flow. The must collected in the part 1B is removed, via a pipe 4, by a pump 5 and conveyed, via a pipe 4A, into a heat exchanger 2 where it is cooled by means of mechanical or cryogenic cold energy supplied to the heat exchanger 2 via pipes 6 and 7.

After cooling, the must, via the line 8, is transferred into the apparatus 1, into the part 1A thereof, which now acts as a device for mixing and ensuring a uniform temperature of the two incoming flows, i.e. the pressed product via the device 3 and the heat carrier via the line 8. The transfer of the cooled must from the cooler 2 to the receptacle 1 may be performed by means of gravity or using transfer systems known per se, such as pumps or the like.

The pressed product thus cooled is conveyed away for the subsequent conversion processes, for example pressing or fermentation, by means of pipes 9 and 9A and a pumping system 10, i.e. components which are known per se.

In the case where mechanical cold energy is used in the invention, the pipes 6 and 7 are connected to a cooling unit having its own cooling circuit, said device being known per se and not shown in the figure. Where a cryogenic fluid (such as nitrogen, argon or carbon dioxide in the liquid state) is used, however, the pipe 6 is connected to a tank for storing the cryogenic fluid and the pipe 7 allows discharging of the vapour of the said fluid formed following heat exchange with the must.

The cryogenic fluid may be used both with and without direct contact with the must to be cooled. In the case where the cryogenic fluid is used without direct contact, the pipes 6 and 7 are combined and convey inside them the cryogenic fluid which, as it advances through them, increases its vapour content until it becomes vapour completely. In this case, there is no contact, and therefore no mixing, between the cryogenic fluid and must and the exchange is performed by separation surfaces.

In the case where cryogenic fluid with direct contact is used, the pipe 6 conveys it into the exchanger 2 where it comes into contact with the must and is converted into vapour, which vapour is discharged via the pipe 7 connected, in this case, to the said exchanger.

By way of a non-limiting example, the part 1A of the receptacle 1 may consist of the press and/or the stalk stripper, this being a machine which is used in wine cellars in order to form the pressed product by pressing and/or removing the stalks from the grapes.

In this case, the actual operation of the press involves the necessary stirring in order to ensure a uniform temperature and, moreover, being normally used, independently of the need or otherwise for cooling, the cooling process may be regarded as a process which does not produce further mechanical stresses on the pressed product.

With reference to FIG. 2, this shows another possible embodiment of the continuously operating plant according to the invention, where the main difference from that shown in FIG. 1 consists in having:

a) two separate apparatus, which are connected by pipes, for separation of the pressed product/must, a separator and, for mixing and ensuring a uniform temperature of heat carrier and pressed product, a mixer;
b) positioning of the separator so that it is situated downstream of the systems for transferring the pressed product to the following processing stages in order to make use of its discharge head for circulation of the must within the cooling circuit.

More particularly, in FIG. 2 the pressed product is supplied, via a special pipe 27, into a receptacle 26 having the sole purpose of allowing correct mixing and ensuring a uniform temperature of the pressed product and the cooled must supplied by means of a line 22A from a cooler 23. The pressed product is drawn off from the receptacle 26, via a pipe 28, using a device for transportation thereof, for example a pump 12, said device being known per se, and is conveyed into a separator 21 by means of a pipe 28A. The separator 21 is composed of three parts or components 21A, 21B and 21C, with functions similar to that described for the components 1A, 1B and 1C of the receptacle 1 according to FIG. 1.

From the component 21B, the must is pushed, via a pipe 22, into the cooler 23 provided with pipes 24 and 25 having functions similar to that described for the pipes 6 and 7 according to FIG. 1.

If permitted by the loss of head of the circuits traveled along by the must, namely the pipe 22 and the exchanger 23, the must is transferred from the component 21B to the cooler 23 without the aid of further pumping devices, but only using the discharge head existing in this part or component 21B.

As mentioned, the pipe 22A allows the cold must coming out of 23 to be conveyed into the mixer 26; said conveying may be performed by means of gravity or using transfer systems, such as pumps or other systems which are known per se, or, if the cooler operates with mechanical or cryogenic cold energy, but without direct contact between the cryogenic fluid and must, and if permitted by the loss of head at 22A, using the existing discharge head of the carrier in the exchanger 23.

In the present case also, purely by way of a non-limiting example, the mixer 26 may be composed of the press and/or stalk stripper.

The volume of the mixer 26 must have values able to ensure an adequate stay time and suitable stirring for ensuring a properly uniform temperature, in a similar manner to that already seen above for the component 1A of FIG. 1.

With reference to FIG. 3, this shows another possible embodiment of the continuously operating plant according to the invention, where the main difference from that shown in FIGS. 1 and 2 consists in having separation of the two flows of material, the must and the pressed product remaining inside a special container, in cooling the must and in combining the cold must and the remaining pressed product inside a special mixer situated downstream of the said separator.

More particularly, in FIG. 3, the pressed product is supplied by means of a special pipe 30 into a receptacle 31 having the purpose of separating the must from the pressed product.

The receptacle, or separator 31, in a similar manner to that described in connection with FIG. 1, where it is indicated by 1, and FIG. 2 where it is indicated by 21, is composed of three parts 31A, 31B and 31C.

The separated must is conveyed by means of the pipe 34 into the cooler 35 provided with pipes 37 and 38 having functions similar to 6 and 7 in FIGS. 1 and 24 and 25 in FIG. 2.

From the cooler 35, the cooled must is conveyed, by means of the pipe 36, into the mixer 33 where it is mixed with the pressed product supplied from the separator 31 via the pipe 32; a uniform temperature of the whole is ensured and the latter transferred to the following conversion stages such as pressing, fermentation or maceration.

FIG. 3 does not show—since of no importance for the purposes of comprehension—conveying components which are necessary for operation of the invention and known per se. These components, however, are equivalent to those already described with reference to FIGS. 1 and 2.

The separator 31, purely by way of a non-limiting example, may consist of the press and/or stalk stripper.

The mixer 33 must have dimensions such as to ensure suitable stay times for the pressed product necessary for achieving a uniform temperature, in a similar manner to that seen for the component 26 in FIG. 2 and the component 1A in FIG. 1, and may consist, purely by way of a non-limiting example, of the press or vat, components which are known per se and present in a wine cellar.

This embodiment has the advantage, compared to that shown in FIGS. 1 and 2, of allowing greater transportation of cold energy per unit of weight of the must, this fact being due to a greater temperature range possible with the latter; more precisely, the temperature range is greater because of the difference in temperature existing between the pressed product to be cooled and the cooled pressed product.

In order to understand this aspect more fully, let us assume that there is a pressed product at a temperature T1 which must be cooled down to a temperature T2.

In the embodiment shown in FIGS. 1 and 2, the must to be cooled is taken from the separator, denoted by 1 in FIG. 1 and by 21 in FIG. 2, which contains the cooled pressed product, namely at a temperature T2; instead, in the embodiment of FIG. 3, the must to be cooled is taken from the separator 31 which contains the pressed product which is not yet cooled, namely at the temperature T1. It is obvious therefore that, in the invention shown in FIG. 3, the must, for the same temperature upon leaving the cooler, has a temperature difference increased by the value T1-T2 compared to that which it would have in the embodiments shown in FIGS. 1 and 2.

The advantage described above is conditioned by the fact that the quantity of must which can be used as a heat carrier and consequently the quantity of hourly cold energy which can be transported by it is limited by the following factors:

a) by its content in the pressed product, since not being used for internal recycling, at the most the quantity thereof present in the incoming flow 30 may be drawn therefrom, unlike that which occurs instead in the continuously operating embodiments shown in FIGS. 1 and 2 where it is possible to accumulate must in order to use it as a heat carrier using typical known internal recycling methods;
b) it must not be of a nature such that the pressed product, devoid of this quantity, acquires a viscosity such as to hinder its flow through the pipe 32 which connects the separator 31 to the mixer 33. This factor obviously is irrelevant if a conveying system is used to connect the separator 31 to the mixer 33, other than pumping, such as, by way of a non-limiting example, a conveyor belt or feeder screw.

In all the embodiments described by FIGS. 1, 2 and 3, in order to minimize in any case the quantity of must to be used as a heat carrier, it is envisaged, in some cases, cooling it until at least partial freezing thereof is obtained so as to allow a greater transportation of cold energy for the same weight, this fact being due to the exchangeable latent heat of the heat carrier, present in this case. In this case (namely if the must is at least partly frozen), it is envisaged that it may be broken up before being transferred or conveyed back into the receptacle 1 (or 26 or 33). If necessary, the latter may be provided directly with means for crushing this fluid.

A further variant to that shown in FIGS. 1, 2 and 3 consists in the fact that, if the nature of the polyphase fluid to be cooled allows it, cooling may be performed using as a heat carrier a part of this fluid as such, without having to separate its liquid component. In this case, the apparatus or device 1 according to FIG. 1 will be without the parts or components 1B and 1C and, in a similar manner, the apparatus 21 according to FIG. 2 will be without the parts or components 21B and 21C, and likewise the apparatus 31 according to FIG. 3 will be without the parts or components 31A, 31B and 31C. Consequently, the components 1 in FIG. 1, 21 in FIGS. 2 and 31 in FIG. 3 or the pipes emerging from them will be provided with systems, known per se, for controlled drawing-off of the flow to be used as heat carrier.

If the invention uses cryogenic cold energy, the vapour which is produced by the fluids which supply them (such as, for example, N₂, CO₂, Ar) following heat exchange with the must may be easily used as vapour for forming mixtures without oxygen or with a limited content of this gas; these mixtures may therefore be used in other must conversion processes (or machines) used in the wine cellar such as, by way of a non-limiting example, in the press and/or stalk stripper denoted by 26 in FIG. 2, by 1A in FIG. 1 and by 31A in FIG. 3.

The invention, moreover, is provided with systems for measuring the temperature, flow rate, pressure and level of the fluid and with flow throttling and regulating parts, all of which are not shown in the figures since they are parts known per se.

The invention may be managed in a completely automated manner using a PLC, computer or portable computer (PC) and other components which are not shown in the figures and known per se.

Various embodiments of the invention have been described; other embodiments are still possible in the light of that described and are to be regarded as falling within the scope of the accompanying claims.

1-38. (canceled)

39. A method for cooling in a controlled manner a polyphase fluid having liquid and solid components, comprising the steps of:
providing a receptacle containing said polyphase fluid;
removing a portion of said polyphase fluid from said receptacle;
cooling said removed portion; and
introducing said cooled portion into said receptacle.

40. The method of claim 39, further comprising the step of separating at least a portion of said liquid components from said solid components wherein said removed portion comprises said separated portion of liquid components and said step of separating is performed before said step of removing.

41. The method of claim 39, further comprising the step of separating said liquid components from said solid components after said step of removing is performed, the heat carrier is separated from the fluid agglomerate in a special separator and then cooled and mixed with the remaining agglomerate, separated previously, inside a special mixer situated downstream of the said separator.

42. The method of claim 41, wherein in the case of pressed grapes, the mixer consists of a press or vat.

43. The method of claim 40, wherein said heat carrier travels along a cooling circuit by means of its own pressure, without the help of machines for its movement or transfer.

44. The method of claim 40, wherein said heat carrier moves, after cooling thereof, by means of gravity when it returns into the receptacle in which the fluid agglomerate is present.

45. The method of claim 39, wherein the heat carrier consists of liquid alone or a polyphase fluid part.

46. The method of claim 39, wherein the heat carrier is a polyphase fluid part.

47. The method of claim 39, wherein cooling of the heat carrier is obtained by means of systems for cooling using cold energy produced with mechanical means.

48. The method of claim 39, wherein cooling of the heat carrier is obtained with the aid of a cryogenic cooling fluid.

49. The method of claim 48, wherein said cryogenic fluid is a liquefied gas.

50. The method of claim 49, wherein said gas is chosen from among N₂, Ar and CO₂.

51. The method of claim 48, wherein the cryogenic fluid is a mixture of liquefied gases chosen from among N₂, Ar and CO₂.

52. The method of claim 48, wherein it envisages using a plurality of cooling fluids in successive stages.

53. The method of claim 48, wherein after withdrawing heat or cooling the heat carrier, said cooling fluid is converted into vapour, the latter therefore being used to form one or more gaseous mixtures with a reduced oxygen content to be used inside the receptacle where the polyphase fluid is present.

54. The method of claim 48, wherein said cooling fluid is placed in direct contact with at least one agglomerate part able to act as a heat carrier.

55. The method of claim 48, wherein said cooling fluid is placed in indirect contact with the at least one agglomerate part able to act as a heat carrier.

56. The method of claim 39, wherein it envisages introducing the agglomerate into a receptacle where this agglomerate is divided into a portion containing mostly a solid phase and a portion containing mostly a liquid phase, the agglomerate part able to act as a heat carrier being drawn from this latter portion.

57. The method of claim 39, wherein the cooled heat carrier is combined with the fluid to be cooled inside an apparatus which, in the case of pressed grapes, is a machine able to press and/or strip the stalks of the grapes.

58. The method of claim 39, wherein the agglomerate is introduced into a receptacle where its liquid and solid phases are indistinguishable.

59. The method of claim 39, wherein the heat carrier is made to circulate by means of the discharge head obtained by means of movement parts.

60. The method of claim 39, wherein supplying of the fluid agglomerate to the receptacle is performed continuously.

61. The method of claim 39, wherein supplying of the fluid agglomerate to the receptacle is performed discontinuously.

62. The method of claim 39, wherein the heat carrier is partially frozen.

63. The method of claim 39, wherein the heat carrier is totally frozen.

64. The method of claim 62, wherein the frozen heat carrier is reduced into small-size parts before being introduced into the storage and uniform temperature receptacle.

65. A plant for cooling a fluid agglomerate or polyphase fluid, comprising a liquid component and a solid component such as for example alimentary juices or the like and in particular pressed grapes, said plant comprising a primary receptacle or container able to contain this fluid in its two components, characterized in that it comprises means for transferring at least a part of this fluid, able to draw it from this receptacle and transfer it to the cooling means to which said draw-off means are connected, said cooling means transferring again subsequently to the fluid agglomerate said at least one polyphase fluid part after cooling thereof, said at least one cooled fluid part acting as a heat carrier for cooling the remaining fluid part.

66. The plant of claim 65, wherein said transfer means consist of a pipe able to allow the movement of the heat carrier by means of gravity.

67. The plant of claim 65, wherein said transfer means are pipes and movement components which are known per se.

68. The plant of claim 65, wherein the cooling means are directly connected to the receptacle.

69. The plant of claim 65, wherein the cooling means are directly connected to a second receptacle able to receive new fluid agglomerate and the heat carrier defined by the cooled agglomerate, producing in this receptacle mixing of the two.

70. The plant of claim 65, wherein the cooling means consist of a cooling device comprising a cooling circuit and able to produce mechanical cold energy for cooling the heat carrier.

71. The plant of claim 65, wherein the cooling means consist of at least a cryogenic fluid.

72. The plant of claim 71, wherein the cryogenic fluid is chosen from among N₂, Ar and CO₂, said fluids being used individually or being mixed together.

73. The plant of claim 71, wherein it comprises a heat exchanger in which the cryogenic fluid is placed in contact with the fluid agglomerate drawn from the primary receptacle or container.

74. The plant of claim 65, wherein it comprises devices for stirring and mixing the agglomerate, situated between the receptacle or primary container or inside each receptacle or container where the heat carrier comes into contact with the polyphase fluid or fluid agglomerate.

75. The plant of claim 65, wherein it is completely automated and controlled and operated with the aid of a microprocessor control unit or by means of a PLC.

76. The plant of claim 64, wherein the primary receptacle or container is insulated.
